(19) United States
(12) Patent Application Publication
(10) Pub. No.: US 2003/0144050 A1
(43) Pub. Date: Jul. 31, 2003

(54) Method, apparatus and computer program product for enhanced bingo game

(76) Inventors: Brett N. Keaton, Rena, NV (US); Michael W. Hartman, Reno, NV (US); Deborah L. Leake, Reno, NV (US); Calvin R. Nicolson, Reno, NV (US); Mark P. Lowell, Reno, NV (US)

Correspondence Address: SIERRA PATENT GROUP, LTD., P O BOX 6149, STATELINE, NV, 89449, US

(21) Appl. No.: 10/060,871

(22) Filed: Jan. 29, 2002

(51) Int. Cl. A63F 13/00

(52) U.S. Cl. 463/19

(57) ABSTRACT

An enhanced game of bingo is disclosed. The method comprises the steps of providing a bingo card to a player, the bingo card including a plurality of numbered spaces having a range of numbers and being arranged in a matrix of rows and columns; providing a random number generator that generates random numbers within the range; providing at least a first set of indicators, the indicators capable of being displayed on the bingo card; designating at least one configuration of at least one pattern of at least one numbered space on the bingo card, the configuration determining a winner of the game; until the at least one configuration of at least one pattern of numbered spaces on the bingo card is matched to at least one indicator from the first set of indicators, iteratively generating a random number, matching the number to its corresponding numbered space if present on the bingo card, and, if the numbered space is not matched to an indicator, then randomly selecting an indicator and matching it to the pattern containing the numbered space; generating additional numbers and matching them to corresponding numeric spaces on the bingo card until the game has ended; and awarding a prize to the player if the bingo card has numbers that match at least part of the configuration of at least one pattern matched with the indicators.

### FIELD OF THE INVENTION

The present invention relates broadly to the game of bingo. Specifically, the present invention relates to an enhancement to the game of bingo including an additional level of matching indicia to numbered spaces on a bingo card. More specifically, the present invention relates to an enhancement to the game of bingo where indicators are randomly selected after the first bingo ball is selected, and the indicators are matched to a configuration of preselected patterns on the bingo card to create a winning bingo card.

### BACKGROUND OF THE INVENTION

Bingo is a game that has been widely played for generations. Balls numbered from 1 to 75 are randomly selected and the number on the ball is read or called to the players. Players maintain one or more bingo cards, each having a matrix of rows and columns containing numbered spaces. Spaces on the bingo card are numbered 1 through 15 in the leftmost or “B” column, 16 through 30 in the next or “I” column, 31 through 45 in the center or “N” column, 46 through 60 in the “G” column, and 61 through 75 in the rightmost or “O” column. As the numbered balls are called, the player places a dauber or marker over the numbered space on the bingo card if the numbered space matches the number called. Players that place daubers in an acceptable pattern over matching numbers win a prize. For example, such patterns on the card can include a column, a row, a diagonal line, all four corners of the card, a cross, an intersection of lines, etc., or even every space on the bingo card. The caller or operator of the bingo game announces the winning pattern before the start of the game.

Bingo is becoming an increasingly popular form of gambling. Players purchase cards, thus contributing to a cash prize paid to the winners. The cost of the card is often dictated by the statistical chance of winning, or the size of the prize. With the advent of electronic bingo, a player can simultaneously play a larger number of bingo cards. One electronic device generates random numbers between 1 and 75 and players use another device to monitor the called numbers and match them to electronic bingo cards. Progressive jackpots, prizes that increase as games are played to completion without a winner, also have attracted more players to the game of bingo.

Bingo still needs an added level of excitement and attraction to compete with traditional automated casino games such as slot machines or video poker machines. In addition to significantly larger jackpots, there needs to be some added level of visual appeal incorporated into the conventional game of bingo.

### SUMMARY OF THE INVENTION

The present invention addresses the problems discussed above and provides a method of playing an enhanced game of bingo. The method comprises the steps of providing a bingo card to a player, the bingo card including a plurality of numbered spaces having a range of numbers and being arranged in a matrix of rows and columns; providing a random number generator that generates random numbers within the range; providing at least a first set of indicators, the indicators capable of being displayed on the bingo card; designating at least one configuration of at least one pattern of at least one numbered space on the bingo card, the configuration determining a winner of the game; until the at least one configuration of at least one pattern of numbered spaces on the bingo card is matched to at least one indicator from the first set of indicators, iteratively generating a random number, matching the number to its corresponding numbered space if present on the bingo card, and, if the numbered space is not matched to an indicator, then randomly selecting an indicator and matching it to the pattern containing the numbered space; generating additional numbers and matching them to corresponding numeric spaces on the bingo card until the game has ended; and awarding a prize to the player if the bingo card has numbers that match at least part of the configuration of at least one pattern matched with the indicators.

Indicators can be colors, graphical symbols, or other visual designations that are viewable on a bingo card. Multiple sets of symbols can be used and their selection combined through the method described herein to provide multiple ways to win the game and to provide prizes. Pattern configurations on the bingo card can be contiguous or noncontiguous, and can be one or more spaces on the bingo card. The method of the present invention can be practiced in conventional games involving a human caller who draws numbered balls from a ball blower at a bingo desk, or may utilize a computer system to randomly generate and call numbers and coordinate play among players.

The bingo card can be in paper form or electronic form, and may be maintained and displayed on a card tending device or personal computer. Electronic embodiments of the method of the present invention can be played in a bingo hall that can be connected to other bingo halls to include additional players and combine prize amounts. Alternatively, in a computer network embodiment, multiple players can connect to a server computer that coordinates play and serves as a caller.

Progressive prize amounts and winning configurations of patterns can be displayed to players. Increases in prize amounts can be calculated over a given period, compressed and displayed at accelerated rates to players to inject a heightened sense of excitement to the game environment.

Many other advantages and features of the present invention will be apparent from the following detailed description and drawings.

### BRIEF DESCRIPTION OF THE DRAWINGS:

FIG. 1 is a flow chart illustrating the logical sequence of steps to perform an embodiment of the method of the present invention;

FIG. 2 is a diagram of a hopper used to randomly draw numbers in accordance with the enhanced game of bingo according to the present invention;

FIGS. 3A and 3B are illustrations of bingo cards used in connection with an embodiment of the enhanced game of bingo according to the present invention;

FIGS. 4A, 4B, and 4C are illustrations of bingo cards used in connection with an alternative embodiment of the enhanced game of bingo according to the present invention;

FIG. 5 is a block diagram of apparatus used in an embodiment of an electronic version of the enhanced game of bingo according to the present invention;

FIGS. 6A and 6B are illustrations of game displays that are shown to players in embodiments of electronic versions of the enhanced game of bingo according to the present invention.

FIG. 7 is a block diagram of an apparatus implemented in components used in an embodiment of an electronic version of the enhanced game of bingo according to the present invention; and

FIG. 8 is a block diagram of an embodiment of the present invention utilizing a computer network.

### DETAILED DESCRIPTION

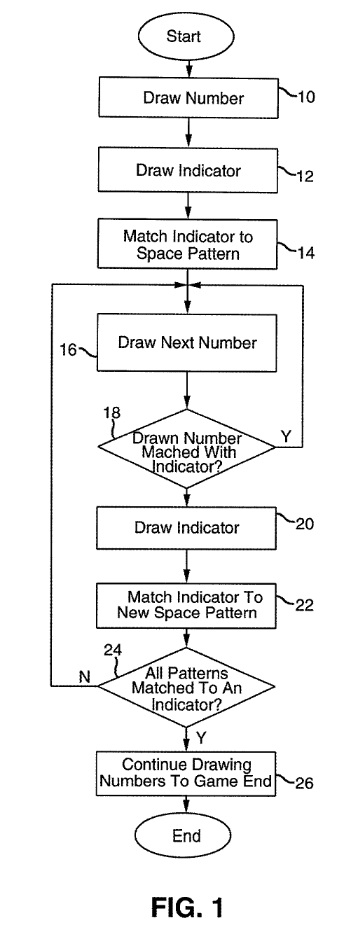

Directing attention to FIG. 1, the basic method for playing an enhanced game of bingo according to the present invention is illustrated in a flow diagram. Players are provided with a bingo card having a conventional layout and a caller randomly selects numbered balls from a plurality of balls numbered from 1 to 75. After the first ball is selected at step 10, an indicator such as a color is randomly selected from a finite number of indicators at step 12. At step 14, the indicator is associated with a predetermined pattern of one or more spaces on the card, such as a column, a row, a corner, or other arrangement of numbered spaces on the bingo card. In a preferred embodiment, five colors out of a set of eight predetermined colors are selected. In an alternative embodiment, the indicator(s) can be selected and displayed to players before the start of the game, but assigned to various spaces on the bingo card after the game begins. The next numbered ball is randomly drawn at step 16. At decision step 18, the number drawn is checked to see if the number corresponds to a pattern that isn't already associated with a color. If the pattern is not associated with a color, another color is then randomly selected from the remaining colors and associated with the pattern. However, if the pattern is already associated with a color, numbered balls are selected at random until a numbered ball is drawn whose number doesn't correspond to a selected color. Decision step 24 directs that steps 16 through 22 be repeated until all columns have been associated with a unique color. Once all columns have been associated with unique colors, the game of bingo continues at step 26 with additional balls being drawn until the game ends.

While the flow diagram of FIG. 1 illustrates conventional numbers and a single layer of indicators applied to a bingo game, those skilled in the art will understand that the method of the present invention can be modified to include multiple layers of indicators as well as indicators from several sets to the same game of bingo. For example, in addition to using color as a first indicator, a graphic such as a treasure chest or pile of coins can also be randomly selected as a secondary indicator and used in the bingo game during play. In this manner, numerous games of chance can be played within a single bingo game, thus increasing the possibility of a player winning a jackpot that exceeds typical bingo payouts.

There are numerous ways for a player to win the enhanced game of bingo according to the present invention. There may be a prize for a bingo win in a single column, such as one color, or there may be a larger prize for multiple column bingo wins, such as two or more colors in different columns, rows, diagonal arrangements, etc. Specific colors can be awarded different prize amounts, such as colors and graphical symbols associated with certain holidays, such as red and green colors or a reindeer graphic for Christmas or red, white and/or blue or American flag graphics for Independence Day. While the above description associates colors with entire columns on a bingo card, the method illustrated in FIG.1 described above can easily be modified to associate colors with rows on a bingo card instead of columns. In an alternative embodiment, corners of the bingo card, or other specific combinations of spaces, can be assigned indicators rather than columns, rows, or diagonal arrangements. The free space, or numbered space in the center of a bingo card, can also be assigned any indicator that facilitates a win, making use of it as a free space in accordance with the enhanced bingo game of the present invention.

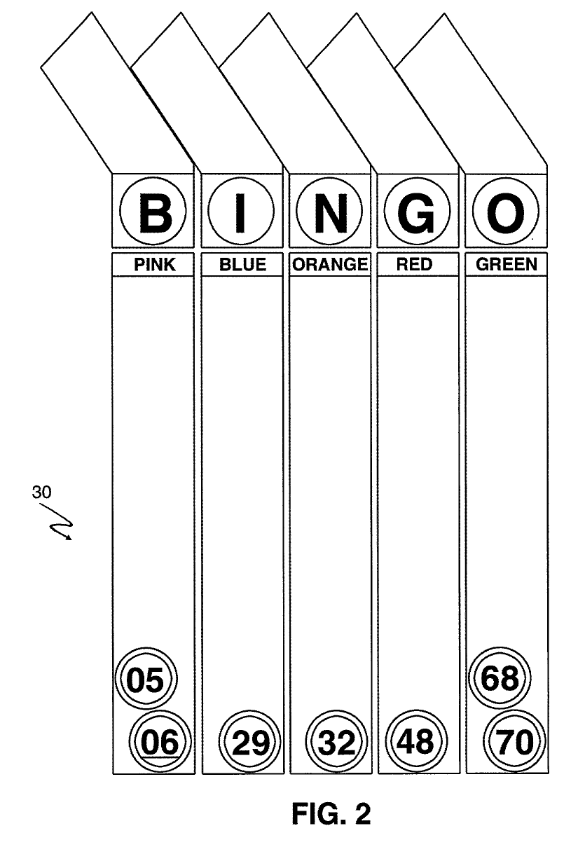

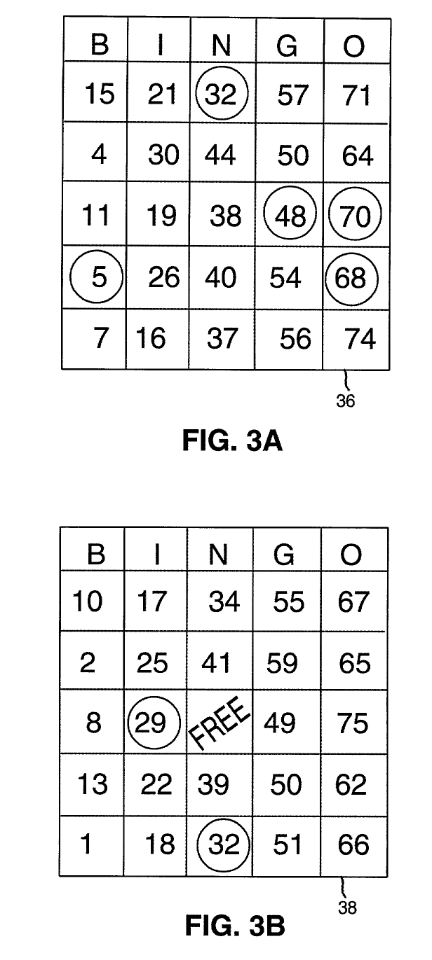

FIG. 2 illustrates the appearance of an exemplary hopper 30 used in an embodiment of the enhanced game of bingo according to the present invention. Hopper 30 can be a conventional bingo ball hopper or a virtual hopper that generates and displays random numbers. As shown in FIG. 2, the first numbered ball drawn is 6, thus falling into the “B” column. The color pink is randomly selected from a group of colors and associated with the entire “B” column on the bingo cards 36, 38 (FIGS. 3A and 3B). The next number drawn is 70, thus falling into the “O” column. The color green is randomly selected from the remaining group of colors and assigned to the entire “O” column on the bingo card. The next number drawn is 68, also falling into the “O” column. Since the “O” column already is associated with the color green, no color selection is made and play continues. 29 is the next number drawn, thus falling into the “I” column. The color blue is randomly selected from the group of remaining colors and associated with the “I” column. 5 is the next number drawn, thus falling into the “B” column. Since the “B” column is already associated with the color pink, no color selection is made and play continues. 32 is the next number drawn, thus falling into the “N” column. Since no color has been associated with the “N” column in this game, the color orange is selected from the remaining colors and associated with the “N” column. The next number drawn is 48, thus falling into the “G” column. Since no color has been associated with the “G” column in this game, the color red is selected from the remaining colors and associated with the “G” column. At this point in the game, all five columns on the bingo cards 36, 38 have been associated with a color. Play continues as in a conventional bingo game, with no further color selection, and numbers are drawn at random until there is a winner in either the conventional game of bingo, the enhanced game of bingo of the present invention, or all numbered balls are drawn.

While the method of the present invention has been described with respect to using color as an enhanced indicator to a game of bingo, there are many preferred variations to the indicators. In an embodiment, indicators such as graphics resembling gemstones are used to implement the method of the present invention. Various combinations of graphics can be obtained to win prizes of varying amounts. Other graphics, such as those illustrating card suites such as hearts, diamonds, clubs and spades can also be used to create winning bingos in the form of straights or flushes.

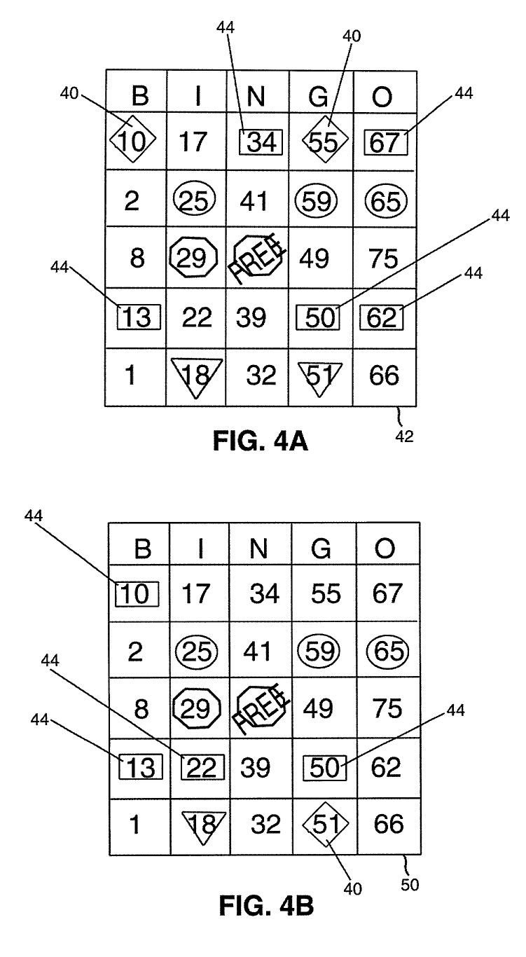

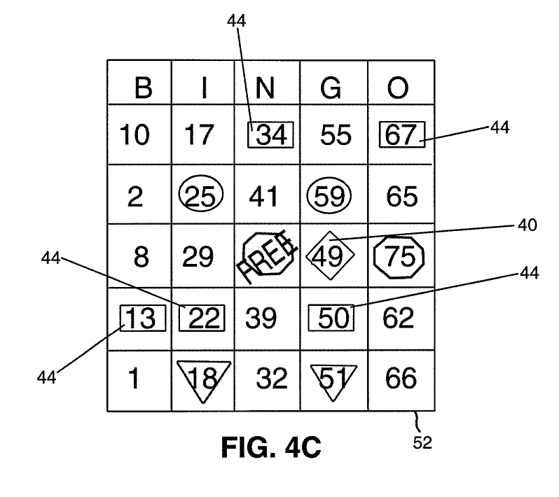

In yet another variation, indicators such as colors or graphics need not be unique for each space pattern. For example, step 20 in FIG. 1 can be modified to select a non-unique indicator from available indicators, such that more than one row, column, etc. can have the same indicator. FIGS. 4A, 4B, and 4C illustrate exemplary bingo cards where the same graphic appears in two rows on each card. Also illustrated is a variation where more than one indicator may appear in the same row or column. As shown in FIG. 4A, a diamond graphic 40 appears in the top row of the bingo card 42 in the “B” and “G” columns and sapphire icon 44 appears in the top row in columns “N” and “O.” The diamond graphic 40 and sapphire graphic 44 appear elsewhere in cards 50, 52 (FIGS. 4B and 4C). Such an embodiment allows for additional prizes of higher amounts, as in the case where the additional graphic appearing on a row is a less likely occurrence in the bingo game.

The enhanced game of bingo according to the present invention can be played in its most basic form such as a conventional, paper system, using physical indicators overlaid on a paper bingo card while a live caller draws numbered balls from a rotating cage. Bingo cards can also be displayed on a video monitor display, hand held electronic display device, or other suitable apparatus.

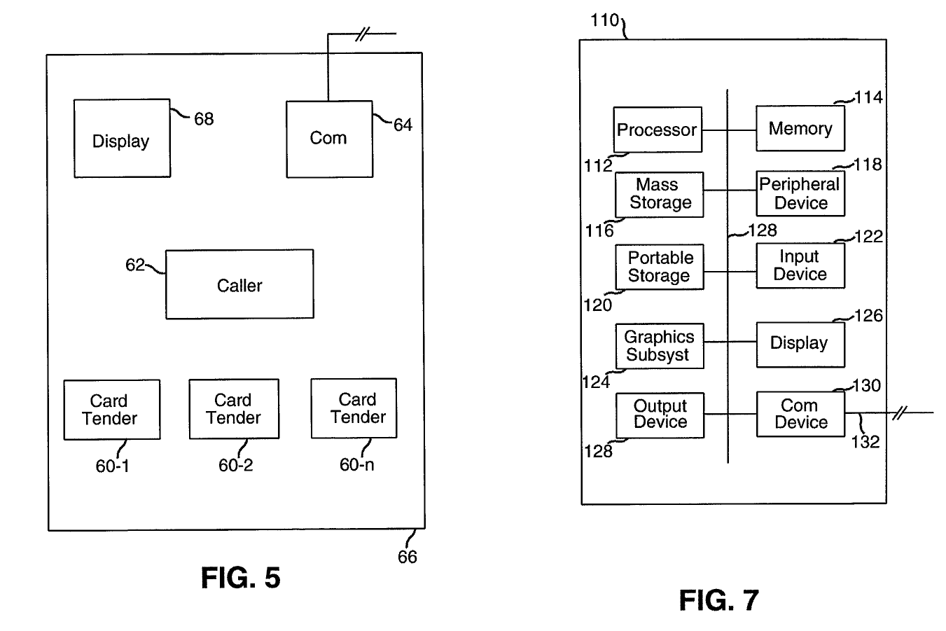

However, for the preferred embodiment, FIG. 5 illustrates in block diagram form the apparatus used when the present invention is implemented as an electronic system that allows players to play large numbers of cards simultaneously using an electronic card tending device, such as currently used in bingo parlors that have gaming licenses. In an electronic embodiment, players use card tending device 60-1, 60-2, through 60-n, where n represents the number of card tending devices available to players. Indicators are placed electronically by the card tending device 60 on electronic versions of bingo cards such as bingo cards 36, 38, 42, 50, 52 stored in its memory. Each electronic bingo card has a unique identification number that allows a bingo win to be verified by the caller 62. The card tending device 60 is in communication with the caller 62. In an embodiment, caller 62 is a system that generates random numbers that are used in place of marked balls used in conventional bingo games. Random number generation in this embodiment is generally known by those skilled in the art and refers to a computer generating a value from a seed in a manner that is unpredictable either by a player or persons operating the bingo hall 66. The caller 62 also randomly selects indicators from a finite set of indicators, and sends both the called random numbers and selected indicators to the card tending devices 60. in an embodiment, number generation can be handled differently, such as by using a ball blower and hopper configuration such as used in conventional bingo games, with a person drawing the numbered balls and entering the values into caller 62. Communication unit 64 can also be in communication with caller 62, and can be used to link bingo hall 66 with other bingo halls to share games and prize amounts with additional players. Communication unit 64 links bingo hall 66 with other bingo halls by connecting to remote communication units over a telephone line or other suitable communication medium.

Display 68 is also in communication with caller 62, and displays the various information to players on a large display screen such as a video monitor in the preferred embodiment. In progressive games using the enhanced bingo game of the present invention, the prize amounts are updated based on win and payout data calculated by the caller 62. Prize amounts can be calculated and displayed on display 68 either by using real time calculations based on current revenues for bingo hall 66 for the day or by using a special technique wherein revenues from a previous period that was longer in duration, such as sales of bingo cards for the entire day previous to the current bingo session, are compressed into a smaller, yet faster incrementing period such as a two hour bingo session. For example, if revenues for the previous day totaled $100,000 on the day prior to the current two hour bingo session, prizes displayed on the display 68 are increased at an accelerated rate by $100,000 during the two hour playing session. The accelerated increases in prize amounts are implemented to introduce a heightened sense of excitement among players.

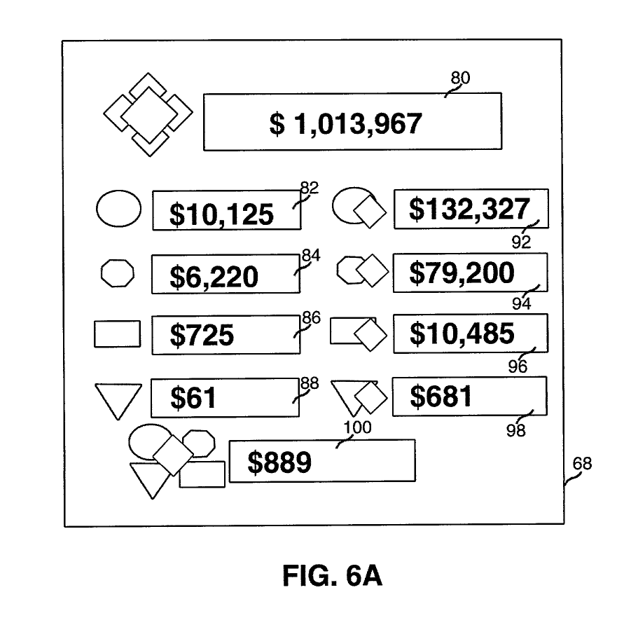

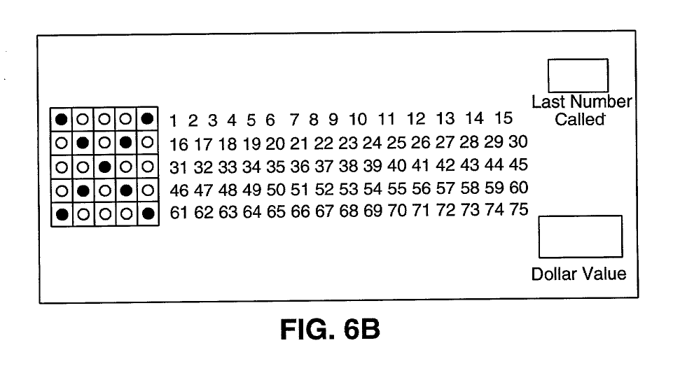

Exemplary screens shown on display 68 are illustrated in FIGS. 6A and 6B. The prizes shown in FIG. 6A correspond to the enhanced bingo game being played using the bingo cards illustrated in FIGS. 4A through 4C. The grand prize 80, having the large jackpot amount, is the most difficult to win. Prizes 82, 84, 86, and 88 have various amounts, but jackpots 92, 94, 96, and 98 are significantly higher because of the combination of indicators. Alternatively, jackpot 100 is relatively low despite having a larger combination of indicators. FIG. 6B illustrates a fashboard type of display 68, including information typically displayed such as game numbers, numbers drawn, pattern of spaces in play, last number called, and game win amount.

FIG. 7 illustrates the various components included in a computer system 110 that may be used to implement caller 62 and communication unit 64. The computer system 110 includes a processor 112 and memory 114. Processor 112 may contain a single microprocessor, or may contain a plurality of microprocessors for configuring the computer system as a multi-processor system. Memory 114 stores, in part, instructions and data for execution by processor 112. If the embodiment of the present invention is wholly or partially implemented in software, including a computer program, memory 114 stores the executable code when in operation. Memory 114 may include banks of dynamic random access memory (DRAM) as well as high speed cache memory. The system 110 further includes a mass storage device 116, peripheral device(s) 118, portable storage medium drive(s) 120, input device(s) 122, a graphics subsystem 124 and a display 126. For simplicity, the components shown in FIG. 2 are depicted as being connected via a single bus 128. However, the components may be connected through one or more data transport means. For example, processor 112 and memory 114 may be connected via a local microprocessor bus, and the mass storage device 116, peripheral device(s) 58, portable storage medium drive(s) 60, and graphics subsystem 124 may be connected via one or more input/output (I/O) buses. Mass storage device 116, which is typically implemented with a magnetic disk drive or an optical disk drive, is a non-volatile storage device for storing data and instructions for use by processor 112. In another embodiment, mass storage device 116 stores the computer program implementing the method of automating an enhanced bingo game for purposes of loading such computer program to memory 114. Instructions for implementing the method of the present invention also may be stored in processor 112. Portable storage medium drive 120 operates in conjunction with a portable non-volatile storage medium, such as a floppy disk, or other computer readable medium, to input and output data and code to and from the computer system 110. In one embodiment, the method of the present invention for automating an enhanced bingo game is stored on such a portable medium, and is input to the computer system 110 via the portable storage medium drive 120. Peripheral device(s) 118 may include any type of computer support device, such as an input/output (I/O) interface, to add additional functionality to the computer system 110. For example, peripheral device(s) 118 may include a network interface card for interfacing computer system 110 to a network, a modem, and the like. Input device(s) 122 provide a portion of a user interface. Input device(s) 122 may include an alphanumeric keypad for inputting alphanumeric and other key information, or a pointing device, such as a mouse, a trackball, stylus or cursor direction keys. In order to display textual and graphical information, the computer system 110 includes graphics subsystem 124 and display 126. Display 126 may include a cathode ray tube (CRT) display, liquid crystal display (LCD), other suitable display devices, or means for displaying system information. Graphics subsystem 124 receives textual and graphical information and processes the information for output to display 126. Additionally, the computer system 110 includes output devices 128. Examples of suitable output devices include speakers, printers, and the like. To connect the computer system 110 to a communication network, communications device 130 controls the flow of data between the computer system 110 and a communication network via communication line 132. The components illustrated in the computer system 110 are those typically found in general purpose computer systems, and are intended to represent a broad category of such computer components that are well known in the art. The computer system of FIG. 7 illustrates one platform that may be used for practically implementing embodiments of the present invention. Numerous other platforms can also suffice, such as Macintosh-based platforms available from Apple Computer, Inc., platforms with different bus configurations, networked platforms, multiprocessor platforms, other personal computers, workstations, mainframes, navigation systems, and the like. Alternative embodiments of the use of the method of the present invention in conjunction with the computer system 110 further include using other display means for the monitor, such as CRT display, LCD display, projection displays, or the like. Likewise, any similar type of memory, other than memory 114, may be used. Other interface apparatus, in addition to the component interfaces, may also be used including alphanumeric keypads, other key information or any pointing devices such as a mouse, trackball, stylus, cursor or direction key.

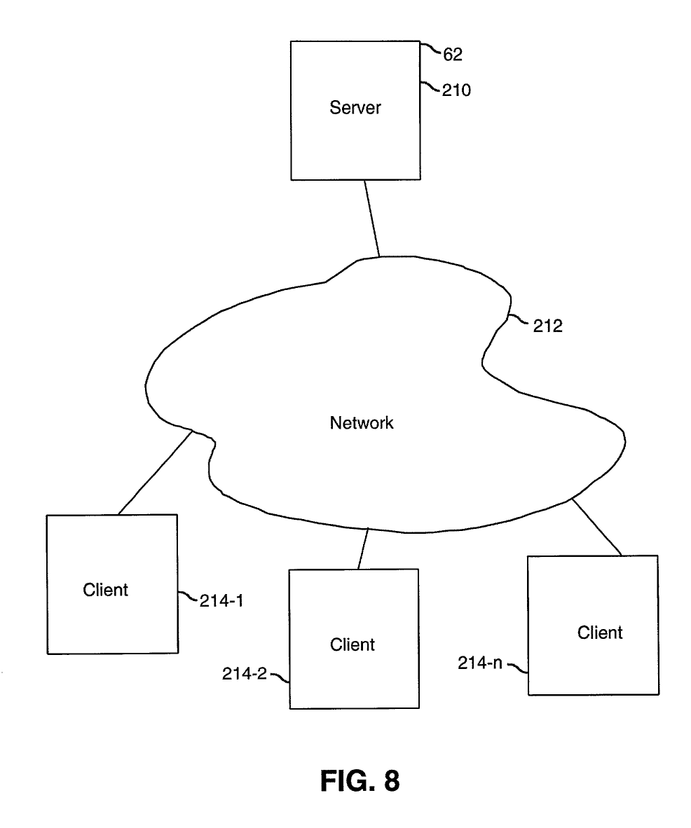

While the present invention has been described above in terms of an electronic embodiment where players use card tending devices to connect to a caller, and bingo halls are linked via telephone lines, the present invention can also be implemented in a client-server computer architecture illustrated in FIG. 8, wherein players connect to a gaming enterprise that operates a caller 62 on server 210 and communicates to players over communication network 212, which may be a global computer network such as the Internet. Players maintain electronic bingo cards and communicate with caller 62 on clients 214-1 through 214-n. In this embodiment, computer system 110 may again be used to implement server 210 and clients 214.

While the invention has been illustrated with respect to several embodiments thereof, these embodiments are to be considered illustrative rather than limiting. Various modifications and additions can be made and will be apparent to those skilled in the art. Accordingly, the invention should not be limited by the foregoing description, but rather should be defined by the following

What is claimed is:

1. A method of playing a game of bingo comprising the steps of:
providing a bingo card to a player, the bingo card including a plurality of numbered spaces having a range of numbers and being arranged in a matrix of rows and columns;
providing a random number generator that generates random numbers within the range;
providing at least a first set of indicators, the indicators capable of being displayed on the bingo card;
designating at least one configuration of at least one pattern of at least one numbered space on the bingo card, the configuration determining a winner of the game;
until the at least one configuration of at least one pattern of numbered spaces on the bingo card is matched to at least one indicator from the first set of indicators, iteratively generating a random number, matching the number to its corresponding numbered space if present on the bingo card, and, if the numbered space is not matched to an indicator, then randomly selecting an indicator and matching it to the pattern containing the numbered space;
generating additional numbers and matching them to corresponding numeric spaces on the bingo card until the game has ended; and
awarding a prize to the player if the bingo card has numbers that match at least part of the configuration of at least one pattern matched with the indicators.

2. The method of claim 1, further comprising the steps of:
providing a second set of indicators;
providing a second configuration of patterns of at least one numbered space on the bingo card, the second configuration determining a winner of the game;
selecting at random at least one indicator from the second set of indicators and matching it to at least one numbered space on the bingo card; and
awarding a prize to the player if the bingo card has numbers that match at least part of the second configuration.

3. The method of claim 1, wherein the set of indicators includes colors.

4. The method of claim 1, wherein the set of indicators includes graphical images.

5. The method of claim 1, wherein the configuration includes a pattern of contiguous spaces on the bingo card.

6. The method of claim 5, wherein the configuration includes a vertical column of numbered spaces on the bingo card.

7. The method of claim 5, wherein the configuration includes a horizontal row of numbered spaces.

8. The method of claim 5, wherein the configuration includes a diagonal pattern of contiguous numbered spaces on the bingo card.

9. The method of claim 1, wherein the configuration includes a pattern of noncontiguous numbered spaces on the bingo card.

10. The method of claim 1, wherein at least one indicator is selected and displayed to the player before the start of the game, but assigned to various spaces on the bingo card after the game begins.

11. The method of claim 1, wherein the random numbers are generated by selecting a ball having a number printed on it from a plurality of balls.

12. The method of claim 1, wherein the bingo card is maintained and displayed electronically by a card tending device.

13. The method of claim 12, wherein the random numbers are generated by a computing device and communicated to the card tending device.

14. The method of claim 1, wherein the prize is progressive.

15. A method of playing a game of bingo comprising the steps of:
providing a bingo card to a player, the bingo card including a plurality of numbered spaces having a range of numbers and being arranged in a matrix of rows and columns;
providing a random number generator that generates random numbers within the range;
providing at least a first set of indicators, the indicators capable of being displayed on the bingo card;
designating at least one configuration of at least one pattern of at least one numbered space on the bingo card, the configuration determining a winner of the game;
until the at least one configuration of at least one pattern of numbered spaces on the bingo card is matched to at least one indicator from the first set of indicators, iteratively generating a random number, matching the number to its corresponding numbered space if present on the bingo card, and, if the numbered space is not matched to an indicator, then randomly selecting an indicator and matching it to the pattern containing the numbered space;
generating additional numbers and matching them to corresponding numeric spaces on the bingo card until the game has ended;
awarding a prize to the player if the bingo card has numbers that match at least part of the configuration of at least one pattern matched with the indicators;
calculating an increase in prize amount from a previous gaming session;
showing on a display an unincremented prize amount; and
incrementing the cash prize shown on the display.

16. The method of claim 15, wherein the prize amount is incremented at an accelerated rate.

17. The method of claim 15, wherein the prize amount is incremented to reflect live updating of the prize amount.

18. The method of claim 15, wherein the set of indicators includes colors.

19. The method of claim 15, wherein the set of indicators includes graphical images.

20. The method of claim 15, wherein the configuration includes a pattern of contiguous spaces on the bingo card.

21. The method of claim 20, wherein the configuration includes a vertical column of numbered spaces on the bingo card.

22. The method of claim 20, wherein the configuration includes a horizontal row of numbered spaces.

23. The method of claim 20, wherein the configuration includes a diagonal pattern of contiguous numbered spaces on the bingo card.

24. The method of claim 15, wherein the configuration includes a pattern of noncontiguous numbered spaces on the bingo card.

25. The method of claim 15, wherein at least one indicator is selected and displayed to the player before the start of the game, but assigned to various spaces on the bingo card after the game begins.

26. The method of claim 15, wherein the random numbers are generated by selecting a ball having a number printed on it from a plurality of balls.

27. The method of claim 15, wherein the bingo card is maintained and displayed electronically by a card tending device.

28. The method of claim 27, wherein the random numbers are generated by a computing device and communicated to the card tending device.

29. The method of claim 15, wherein the prize is progressive.

30. A method of displaying a progressive cash prize during a gaming session to a player comprising the steps of:
calculating an increase in prize amount from a previous gaming session; showing on a display an unincremented prize amount; and
incrementing the cash prize shown on the display at an accelerated rate.

31. A method of playing a game of bingo comprising the steps of:
providing a bingo card to a player, the bingo card including a plurality of numbered spaces having a range of numbers and being arranged in a matrix of rows and columns;
providing a random number generator that generates random numbers within the range;
providing at least a first set of colors, the colors capable of being displayed on the bingo card;
designating at least one configuration of at least one pattern of at least one numbered space on the bingo card, the configuration determining a winner of the game;
until the at least one configuration of at least one pattern of numbered spaces on the bingo card is matched to at least one color from the first set of colors, iteratively generating a random number, matching the number to its corresponding numbered space if present on the bingo card, and, if the numbered space is not matched to a color, then randomly selecting a color and matching it to the pattern containing the numbered space;
generating additional numbers and matching them to corresponding numeric spaces on the bingo card until the game has ended; and
awarding a prize to the player if the bingo card has numbers that match at least part of the configuration of at least one pattern matched with the colors.

32. The method of claim 31, further comprising the steps of:
providing a second set of graphical images;
providing a second configuration of patterns of at least one numbered space on the bingo card, the second configuration determining a winner of the game;
selecting at random at least one graphical image from the second set of graphical images and matching it to at least one numbered space on the bingo card; and awarding a prize to the player.

33. The method of claim 31, wherein the set of indicators includes colors.

34. The method of claim 31, wherein the set of indicators includes graphical images.

35. The method of claim 31, wherein the configuration includes a pattern of contiguous spaces on the bingo card.

36. The method of claim 35, wherein the configuration includes a vertical column of numbered spaces on the bingo card.

37. The method of claim 35, wherein the configuration includes a horizontal row of numbered spaces.

38. The method of claim 35, wherein the configuration includes a diagonal pattern of contiguous numbered spaces on the bingo card.

39. The method of claim 31, wherein the configuration includes a pattern of noncontiguous numbered spaces on the bingo card.

40. The method of claim 31, wherein at least one indicator is selected and displayed to the player before the start of the game, but assigned to various spaces on the bingo card after the game begins.

41. The method of claim 31, wherein the random numbers are generated by selecting a ball having a number printed on it from a plurality of balls.

42. The method of claim 31, wherein the bingo card is maintained and displayed electronically by a card tending device.

43. The method of claim 42, wherein the random numbers are generated by a computing device and communicated to the card tending device.

44. The method of claim 31, wherein the prize is progressive.

45. A method of playing a game of bingo comprising the steps of:
providing a bingo card to a player, the bingo card including a plurality of numbered spaces having a range of numbers and being arranged in a matrix of rows and columns;
providing a random number generator that generates random numbers within the range;
providing at least a first set of graphical images, the graphical images capable of being displayed on the bingo card;
designating at least one configuration of at least one pattern of at least one numbered space on the bingo card, the configuration determining a winner of the game;
until the at least one configuration of at least one pattern of numbered spaces on the bingo card is matched to at least one indicator from the first set of graphical images, iteratively generating a random number, matching the number to its corresponding numbered space if present on the bingo card, and, if the numbered space is not matched to a graphical image, then randomly selecting a graphical image and matching it to the pattern containing the numbered space;
generating additional numbers and matching them to corresponding numeric spaces on the bingo card until the game has ended; and
awarding a prize to the player if the bingo card has numbers that match at least part of the configuration of at least one pattern matched with the graphical images.

46. The method of claim 45, further comprising the steps of:
providing a second set of colors;
providing a second configuration of patterns of at least one numbered space on the bingo card, the second configuration determining a winner of the game;
selecting at random at least one indicator from the second set of colors and matching it to at least one numbered space on the bingo card; and
awarding a prize to the player.

47. The method of claim 45, wherein the set of indicators includes colors.

48. The method of claim 45, wherein the set of indicators includes graphical images.

49. The method of claim 45, wherein the configuration includes a pattern of contiguous spaces on the bingo card.

50. The method of claim 49, wherein the configuration includes a vertical column of numbered spaces on the bingo card.

51. The method of claim 49, wherein the configuration includes a horizontal row of numbered spaces.

52. The method of claim 49, wherein the configuration includes a diagonal pattern of contiguous numbered spaces on the bingo card.

53. The method of claim 45, wherein the configuration includes a pattern of noncontiguous numbered spaces on the bingo card.

54. The method of claim 45, wherein at least one indicator is selected and displayed to the player before the start of the game, but assigned to various spaces on the bingo card after the game begins.

55. The method of claim 45, wherein the random numbers are generated by selecting a ball having a number printed on it from a plurality of balls.

56. The method of claim 45, wherein the bingo card is maintained and displayed electronically by a card tending device.

57. The method of claim 56, wherein the random numbers are generated by a computing device and communicated to the card tending device.

58. The method of claim 45, wherein the prize is progressive.

59. A computer program product containing instructions which, when executed by a computer, performs the steps of:
providing a bingo card to a player, the bingo card including a plurality of numbered spaces having a range of numbers and being arranged in a matrix of rows and columns;
providing a random number generator that generates random numbers within the range;
providing at least a first set of indicators, the indicators capable of being displayed on the bingo card;
designating at least one configuration of at least one pattern of at least one numbered space on the bingo card, the configuration determining a winner of the game;
until the at least one configuration of at least one pattern of numbered spaces on the bingo card is matched to at least one indicator from the first set of indicators, iteratively generating a random number, matching the number to its corresponding numbered space if present on the bingo card, and, if the numbered space is not matched to an indicator, then randomly selecting an indicator and matching it to the pattern containing the numbered space;
generating additional numbers and matching them to corresponding numeric spaces on the bingo card until the game has ended; and
awarding a prize to the player if the bingo card has numbers that match at least part of the configuration of at least one pattern matched with the indicators.

60. A computer program product containing instructions which, when executed by a computer, performs the steps of:
providing a bingo card to a player, the bingo card including a plurality of numbered spaces having a range of numbers and being arranged in a matrix of rows and columns;
providing a random number generator that generates random numbers within the range;
providing at least a first set of indicators, the indicators capable of being displayed on the bingo card;
designating at least one configuration of at least one pattern of at least one numbered space on the bingo card, the configuration determining a winner of the game;
until the at least one configuration of at least one pattern of numbered spaces on the bingo card is matched to at least one indicator from the first set of indicators, iteratively generating a random number, matching the number to its corresponding numbered space if present on the bingo card, and, if the numbered space is not matched to an indicator, then randomly selecting an indicator and matching it to the pattern containing the numbered space;
generating additional numbers and matching them to corresponding numeric spaces on the bingo card until the game has ended;
awarding a prize to the player if the bingo card has numbers that match at least part of the configuration of at least one pattern matched with the indicators;
calculating an increase in prize amount from a previous gaming session; showing on a display an unincremented prize amount; and
incrementing the cash prize shown on the display.

61. A computer program product containing instructions which, when executed by a computer, performs the steps of:
providing a bingo card to a player, the bingo card including a plurality of numbered spaces having a range of numbers and being arranged in a matrix of rows and columns;
providing a random number generator that generates random numbers within the range;
providing at least a first set of colors, the colors capable of being displayed on the bingo card;
designating at least one configuration of at least one pattern of at least one numbered space on the bingo card, the configuration determining a winner of the game;
until the at least one configuration of at least one pattern of numbered spaces on the bingo card is matched to at least one color from the first set of colors, iteratively generating a random number, matching the number to its corresponding numbered space if present on the bingo card, and, if the numbered space is not matched to a color, then randomly selecting a color and matching it to the pattern containing the numbered space;
generating additional numbers and matching them to corresponding numeric spaces on the bingo card until the game has ended; and
awarding a prize to the player if the bingo card has numbers that match at least part of the configuration of at least one pattern matched with the colors.

62. A computer program product containing instructions which, when executed by a computer, performs the steps of:
providing a bingo card to a player, the bingo card including a plurality of numbered spaces having a range of numbers and being arranged in a matrix of rows and columns;
providing a random number generator that generates random numbers within the range;
providing at least a first set of graphical images, the graphical images capable of being displayed on the bingo card;
designating at least one configuration of at least one pattern of at least one numbered space on the bingo card, the configuration determining a winner of the game;
until the at least one configuration of at least one pattern of numbered spaces on the bingo card is matched to at least one indicator from the first set of graphical images, iteratively generating a random number, matching the number to its corresponding numbered space if present on the bingo card, and, if the numbered space is not matched to a graphical image, then randomly selecting a graphical image and matching it to the pattern containing the numbered space;
generating additional numbers and matching them to corresponding numeric spaces on the bingo card until the game has ended; and
awarding a prize to the player if the bingo card has numbers that match at least part of the configuration of at least one pattern matched with the graphical images.

63. Apparatus for playing an enhanced game of bingo, comprising:
a random number generator that generates random numbers within a range of numbers, the range of numbers corresponding to a bingo card having a plurality of numbered spaces arranged in a matrix of rows and columns;
at least a first set of indicators, the indicators capable of being displayed on the bingo card;
at least one configuration of at least one pattern of at least one numbered space on the bingo card, the configuration determining a winner of the game; and
a selection means for determining the winner that iteratively generates a random number, matches the number to its corresponding numbered space if present on the bingo card, and, if the numbered space is not matched to an indicator, then randomly selects an indicator and matches it to the pattern containing the numbered space until the at least one configuration of at least one pattern of numbered spaces on the bingo card is matched to at least one indicator from the first set of indicators, and then generates additional numbers and matches them to corresponding numeric spaces on the bingo card until the game has ended.
